(19) United States
(12) Patent Application Publication
(10) Pub. No.: US 2024/0256941 A1
(43) Pub. Date: Aug. 1, 2024

(54) LEARNING SYSTEM, LEARNING METHOD, AND PROGRAM

(71) Applicant: RAKUTEN GROUP, INC.

(72) Inventor: Kyosuke TOMODA, Setagaya-ku, Tokyo (JP)

(21) Appl. No.: 18/018,269

(22) PCT Filed: Jan. 7, 2022
(86) PCT No.: PCT/JP2022/000352

§ 371 Date: Jan. 27, 2023

(51) Int. Cl. G06N 20/00

(52) U.S. Cl. CPC G06N 20/00

(57) ABSTRACT

A learning system, comprising at least one processor configured to: determine whether each of a plurality of pieces of first data satisfies a first condition relating to labeling; create a first learning model capable of the labeling based on a first group being a group of pieces of the first data which satisfy the first condition and which are labeled; convert a second group being a group of pieces of the first data which do not satisfy the first condition and which are not labeled so that a distribution of the second group is close to a distribution of the first group; and execute the labeling for the second group based on the first learning model and the second group.

### TECHNICAL FIELD

The present disclosure relates to a learning system, a learning method, and a program.

### BACKGROUND ART

Hitherto, there has been known a technology of executing labeling based on a learning model which has been caused to learn labeled training data. It takes a lot of time and effort to manually prepare a large amount of training data, and hence there is also known a method for saving the time and effort for preparing the training data by using a learning model which has been caused to learn a small amount of training data. As an example of this method, transfer learning is known.

For example, in Non Patent Literature 1, there is described a technology of causing a learning model to learn a small amount of labeled training data through use of the transfer learning to label a large amount of unlabeled data. The technology as described in Non Patent Literature 1 converts the unlabeled data so that the unlabeled data has a distribution similar to that of the labeled training data, and then uses the learning model to execute the labeling.

### CITATION LIST

### Non Patent Literature

[NPL 1] Y Ganin and V Lempitsky, Unsupervised Domain Adaptation by Backpropagation, ICML 2015, [retrieved on Dec. 27, 2021], Internet, <URL: https://arxiv. org/pdf/1409.7495.pdf>

### SUMMARY OF INVENTION

### Technical Problem

It takes a lot of time and effort to manually label all data that can serve as the training data. Thus, the inventor (s) is (are) investigating using a group of pieces of data satisfying a condition for the labeling as a target of the labeling, to thereby reduce the time and effort of the labeling. In this case, data which does not satisfy the condition cannot be the target of the labeling in the first place, and cannot thus be labeled. There may exist a large amount of useful data as the training data among the data which does not satisfy the condition, but it is not possible to cause the learning model to learn such data.

When the data which does not satisfy the condition is to be labeled, manual labeling is required for this data, and thus requires time and effort. In this respect, the technology of Non Patent Literature 1 is a technology of automatically labeling the unlabeled data, but simply labels a small amount of data selected randomly. The data selected randomly is not the data which does not satisfy the condition relating to the labeling, and hence the technology of Non Patent Literature 1 cannot label the data which does not satisfy the condition relating to the labeling without time and effort.

One object of the present disclosure is to label data which does not satisfy a condition relating to the labeling without time and effort.

### Solution to Problem

According to one aspect of the present disclosure, there is provided a learning system including: a first determination module configured to determine whether each of a plurality of pieces of first data satisfies a first condition relating to labeling; a first learning model creation module configured to create a first learning model capable of the labeling based on a first group being a group of pieces of the first data which satisfy the first condition and which are labeled; a second group conversion module configured to convert a second group being a group of pieces of the first data which do not satisfy the first condition and which are not labeled so that a distribution of the second group is close to a distribution of the first group; and a second group labeling module configured to execute the labeling for the second group based on the first learning model and the second group converted by the second group conversion module.

### Advantageous Effects of Invention

According to the present disclosure, it is possible to label the data which does not satisfy the condition relating to the labeling without time and effort.

### BRIEF DESCRIPTION OF DRAWINGS

FIG. 1 is a diagram for illustrating an example of an overall configuration of a learning system.

FIG. 2 is a diagram for illustrating an example of fraud detection executed in an SNS.

FIG. 3 is a diagram for illustrating an overview of the learning system.

FIG. 4 is a functional block diagram for illustrating an example of functions implemented in the learning system.

FIG. 5 is a table for showing an example of a target database.

FIG. 6 is a table for showing an example of a first group database.

FIG. 7 is a table for showing an example of a second group database.

FIG. 8 is a diagram for illustrating an example of processing of converting the second group.

FIG. 9 is a flowchart for illustrating an example of processing executed in the learning system.

FIG. 10 is diagram for illustrating an example of functional blocks in modification examples.

FIG. 11 is a diagram for illustrating an example of distributions of a first group to a fourth group.

### DESCRIPTION OF EMBODIMENTS

### 1. Overall Configuration of Learning System

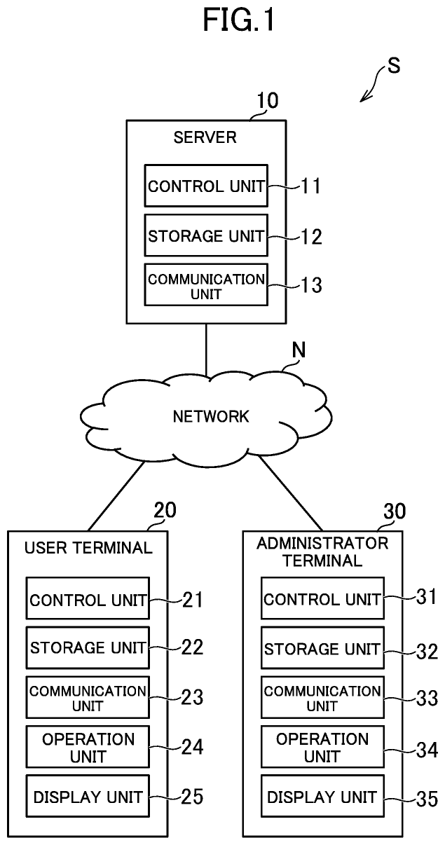

Description is now given of an example of an embodiment of a learning system according to the present disclosure. FIG. 1 is a diagram for illustrating an example of an overall configuration of the learning system. A learning system S includes a server 10, a user terminal 20, and an administrator terminal 30. A network N is any type of network, such as the Internet or a LAN. It suffices for the learning system S to include at least one computer, and the learning system S is not limited to the example of FIG. 1.

The server 10 is a server computer. A control unit 11 includes at least one processor. A storage unit 12 includes a volatile memory such as a RAM and a nonvolatile memory such as a hard disk drive. A communication unit 13 includes at least one of a communication interface for wired communication or a communication interface for wireless communication.

The user terminal 20 is a computer for a user. For example, the user terminal 20 is a personal computer, a smartphone, a tablet terminal, or a wearable terminal. Physical configurations of the control unit 21, the storage unit 22, and the communication unit 23 are equivalent to those of the control unit 11, the storage unit 12, and the communication unit 13, respectively. An operation unit 24 is an input device such as a mouse or a touch panel. A display unit 25 is a liquid crystal display or an organic EL display.

The administrator terminal 30 is a computer for an administrator. For example, the administrator terminal 30 is a personal computer, a smartphone, a tablet terminal, or a wearable terminal. Physical configurations of a control unit 31, a storage unit 32, a communication unit 33, an operation unit 34, and a display unit 35 are equivalent to those of the control unit 11, the storage unit 12, the communication unit 13, the operation unit 24, and the display unit 25, respectively.

Programs stored in the storage units 12, 22, and 32 may be supplied through the network N. Moreover, each computer may include at least one of a reading unit (for example, a memory card slot) for reading a computer-readable information storage medium or an input/output unit (for example, a USB port) for inputting/outputting data from/to an external device. For example, a program stored in the information storage medium may be supplied through at least one of the reading unit or the input/output unit.

### 2. Overview of Learning System

In this embodiment, there is exemplified a case in which the learning system S is applied to fraud detection in a social network service (SNS). A service being a target of the fraud detection may be any type of service, and is thus not limited to the SNS. An example of other services is described in modification examples described later. The learning system S can be used for any purpose other than the fraud detection. Examples of the use for a different purpose are also described in the modification examples described later. In this embodiment, a configuration relating to the fraud detection in the SNS is characteristic. As a configuration itself for providing the SNS, publicly-known various types of configurations can be used.

The fraud detection is detection of a fraudulent act. The fraudulent act is an act deviating from a valid use of a service. For example, the fraudulent act is an act violating terms of use of the service, an act violating a law, or other nuisance. For example, in the SNS, posting to smear another person, posting to urge trade of an illegal article, a senselessly large amount of posting, and impersonating another person to fraudulently log in correspond to the fraudulent act. A user who has registered to use the SNS sometimes conducts the fraudulent act, or a third party who has not registered to use the SNS sometimes conducts the fraudulent act.

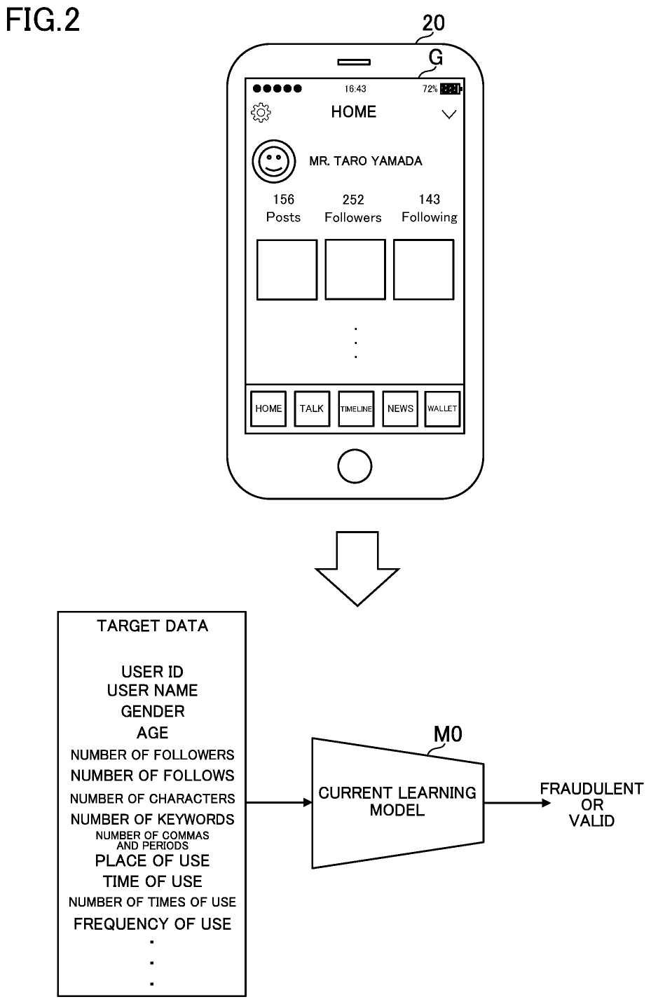

FIG. 2 is a diagram for illustrating an example of the fraud detection executed in the SNS. In this embodiment, description is given of a case in which the server 10 executes both of the provision of the SNS and the fraud detection, but the provision of the SNS and the fraud detection may be executed by computers different from each other. For example, when the user operates the user terminal 20 to log in to the SNS, a top screen G of the SNS is displayed on the user terminal 20. The user can use various services provided by the SNS from the top screen G.

In this embodiment, there is exemplified a case in which the fraud detection is executed when the user posts something to the SNS. The execution timing of the fraud detection may be any timing, and is not limited to the timing of the posting. For example, the fraud detection may be executed when the user logs in, or the fraud detection may be executed when the user comments on a post of another user. Moreover, for example, the fraud detection may be executed when the user accesses a specific page on the SNS. For example, the server 10 executes the fraud detection in the SNS based on target data used in the fraud detection and a current learning model M0.

The target data is data to be labeled in the fraud detection. The labeling is processing of classifying the target data. In the fraud detection in this embodiment, processing of estimating whether or not fraud exists corresponds to the labeling. For example, any one of a first label indicating fraud or a second label indicating validity (non-fraud) is added to the target data through the labeling. In this embodiment, the target data is data on features of a user or a third party who uses the SNS. For example, the target data includes at least one of static items or dynamic items.

The static item is an item which principally does not change for the same user ID. The static item is user information registered in the SNS in advance. The user information may be any information on the user, and is, for example, a name, a gender, an email address, an age, a date of birth, an occupation, a nationality, an area of living, or an address. Information called “demographic information” indicating attributes of the user is an example of the user information.

The dynamic item is an item which may change each time even for the same user ID. The dynamic item is not information registered in advance, and is information generated or acquired on site. In the SNS in this embodiment, contents of an uploaded post, a viewed post, contents of another operation, a place of use, a time of use, the number of times of use, a frequency of use, or a type of the user terminal 20 corresponds to the dynamic items.

Meaning of the term “learning model” of the learning model M0 also applies to a first learning model M1 to a fourth learning model M4 described later. The learning model M0 of FIG. 2 and the first learning model M1 to the fourth learning model M4 are herein collectively simply referred to as “learning models M.” In order to distinguish those learning models, the symbol “M” is suffixed by any one of numerical values of “0” to “4”. The learning models M are the same in terms of the meaning of “learning model,” but are different in creation method for training data.

The learning model M is a model which uses machine learning. The learning model M is sometimes called “artificial intelligence (AI).” For the machine learning itself, various publicly-known methods can be used. As used in this embodiment, the term “machine learning” includes deep learning and reinforcement learning. The learning model M may be any one of supervised machine learning, semi-supervised machine learning, or unsupervised machine learning. For example, the learning model M may be a neural network. As the learning model M itself, various models used in the publicly-known fraud detection can be used.

For example, when the target data is input, the learning model M calculates a feature amount of the target data, and labels the target data based on the feature amount. In this embodiment, a case in which the feature amount is expressed as a multi-dimensional vector is exemplified, but the feature amount can be expressed in any form, and is not limited to the multi-dimensional vector. For example, the feature amount may be expressed as an array or a single numerical value. In this embodiment, description is given of a case in which the learning model M outputs any one of a first value indicating fraud or a second value indicating non-fraud, but the learning model M may output, instead of the binary information, a score having an intermediate value such as a fraudulent probability of 30%. The score indicates a probability of belonging to each label.

In this embodiment, it is assumed that when a certain post is made to the SNS, the target data is generated immediately. The target data may immediately be input to the current learning model M0, or may be input to the learning model M0 after a certain period of time (for example, several minutes to several months) has elapsed. That is, when a certain post is made on the SNS, the fraud detection may be executed in real time, or the fraud detection may be executed after a certain period of time has elapsed.

For example, it is assumed that a malicious third party fraudulently obtains a user ID and a password, and impersonates a valid user to conduct a fraudulent act on the SNS. In this case, it is not considered that the third party exists in the vicinity of the valid user, and it is thus often the case that a place at which the valid user usually uses the SNS and a place at which the third party impersonates the valid user to use the SNS are different from each other. Moreover, for example, a time at which the valid user usually uses the SNS and a time at which the third party impersonates the valid user to use the SNS are sometimes different from each other. Thus, in order to detect the fraudulent act of the third party, items, such as the place of use and the time of use, of the target data may be effective.

Meanwhile, there is a case in which a malicious user uses the own user ID and password to log in, and executes a fraudulent act in the SNS. The fraudulent act of the user who uses the own user ID and password to conduct the fraudulent act is hereinafter referred to as “fraudulent act of the user.” The fraudulent act of the user may be executed at a place at which the user usually uses the SNS. Further, the fraudulent act of the user may be executed at a time at which the user usually uses the SNS. Thus, in order to detect the fraudulent act of the user, items, such as the place of use and the time of use, of the target data may not be very effective. That is, items effective for the detection of the fraudulent act of the user and items effective for the detection of the fraudulent act of the third party may be different from each other.

Further, when the fraudulent act of the third party occurs, the user ID and password fraudulently obtained are used for the fraudulent act, and hence the valid user who is a victim often notices the fraudulent act, and reports to the administrator. When the administrator receives the report from the valid user, the administrator analyzes the target data at the time when the fraudulent act by the third party occurred, to thereby create training data for the learning model M0. The administrator causes the learning model M0 to learn the created training data so that a similar fraudulent act can immediately be detected when the similar fraudulent act occurs. Thus, it may relatively be easy to create the training data for detecting the fraudulent act of the third party.

Meanwhile, when the fraudulent act of the user occurs, the fraudulent act is conducted while the own user ID and password of the user are used, and hence the report to the administrator is less likely to be made than in the case of the fraudulent act of the third party. For example, it is considered that a smearing post is reported by a victim, but, in a case of another fraudulent act such as a large number of posts obstructing operation of the SNS, the administrator is the only victim, and hence no one may report. In this case, the administrator may be delayed in noticing the occurrence of the fraudulent act, or may not be able to notice the fraudulent act in the first place. Thus, it may relatively be difficult to create the training data for detecting the fraudulent act of the user.

In this respect, it takes a lot of time and effort for the administrator to monitor the entire target data, to thereby create the training data for the learning model M0 for detecting the fraudulent act of the user, and this method is thus not practical. Thus, it is also considered that the administrator defines a rough rule considered to correspond to features of the fraudulent act of the user, and sets only target data satisfying this rule as the target of monitoring, to thereby create the training data.

However, target data which does not satisfy the rule is not monitored at all, and cannot thus be used as the training data. The monitoring by the administrator only corresponds to checking whether or not the rule is effective, and hence accuracy of the fraud detection by the learning model M0 may not be much different from accuracy of the rule. Thus, in this embodiment, the target data which does not satisfy the rule and is thus not to be monitored is automatically labeled.

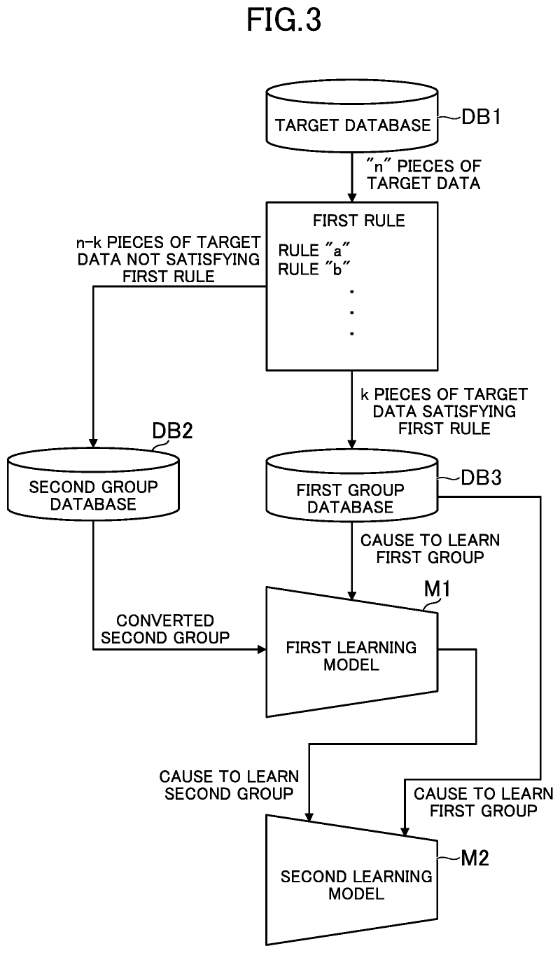

FIG. 3 is a diagram for illustrating an overview of the learning system S. For example, the server 10 stores a target database DB1 which stores a large amount of target data. The server 10 acquires “n” (“n” is an integer equal to or larger than 2, and is, for example, several tens to several thousands or more) pieces of target data from the target database DB1. The server 10 determines whether or not each of the “n” pieces of target data satisfies the current rule. The current rule is hereinafter referred to as “first rule.”

In the example of FIG. 3, the first rule includes a plurality of rules such as a rule “a”, a rule “b”, . . . . The rule is a condition which can be determined based on the item included in the target data. For example, when such a tendency that the number of characters of the post is 500 or more exists as a tendency of the fraudulent act of the user, the administrator defines, as the rule “a”, a rule: “a post including 500 characters or more is to be monitored.” For example, when such a tendency that the number of specific keywords in one post is five or more exists as a tendency of the fraudulent act of the user, the administrator defines, as the rule “b”, a rule: “target data including five or more specific keywords is to be monitored.” Other rules are similarly defined by the administrator identifying tendencies of the fraudulent act of the user through past monitoring, to thereby define the first rule.

Each rule included in the first rule indicates a relationship between a value of the item included in the target data and whether or not the target data is to be monitored (whether or not to be included in a first group or whether or not fraudulent). The rule is used to successively determine the values of the items included in the target data as in a conditional branching in a flowchart. For example, the rule may have a form called “decision tree.” A method of the machine learning of creating the decision tree from data is sometimes called “decision tree learning,” and the rule thus sometimes corresponds to a method of the machine learning. As the rule itself, various rules used in the publicly-known fraud detection can be used.

When the target data satisfies any one of the plurality of rules included in the first rule, the target data may be determined to satisfy the first rule, or when the target data satisfies a predetermined number of rules or more, the target data may be determined to satisfy the first rule. Moreover, for example, a score is associated with each rule, and when a total of the scores of rules which the target data satisfies is equal to or larger than a threshold value, the target data may be determined to satisfy the first rule. The first rule may not include a plurality of rules as illustrated in FIG. 3, but a single rule may correspond to the first rule.

For example, it is assumed that, of the “n” pieces of target data, the number of pieces of target data satisfying the first rule is “k” (“k” is an integer equal to or smaller than “n”). The number of pieces of target data not satisfying the first rule is n-k. A group of the “k” pieces of target data satisfying the first rule is hereinafter referred to as “first group.” A group of the n-k pieces of target data not satisfying the first rule is referred to as “second group.” The first group is to be monitored, and is thus labeled by the administrator.

The administrator displays contents of the “k” pieces of target data belonging to the first group on the administrator terminal 30. The administrator checks the contents of the “k” pieces of target data, and adds the label indicating whether or not the target data is the fraud. The second group is not to be monitored, and is thus not labeled by the administrator. The server 10 creates the first learning model M1 based on the first group labeled by the administrator. As described above, the accuracy of the fraud detection by the first learning model M1 is sometimes not very different from that of the first rule.

One of objects of this embodiment is to automatically label the second group not to be monitored. In order to achieve this object, it is considered that the n-k pieces of target data belonging to the second group are input to the first learning model M1. However, contents of the first learning model M1 are sometimes not very different from the first rule, and hence, even when the n-k pieces of target data belonging to the second group are input to the first learning model M1, the label indicating non-fraud may be added to most of the target data. That is, the same result as that of the first rule is sometimes obtained.

In view of this, the server 10 converts the second group so that a distribution of the second group is close to a distribution of the first group. For this conversion itself, a method of Non Patent Literature 1 as described in the “Background Art” section can be used. As a result of this conversion, the first learning model M1 comes to be capable of identifying a feature of an item other than the item of the target data considered as important in the current labeling. That is, as a result of such conversion that the distribution of the second group is close to the distribution of the first group, the first learning model M1 comes to label the second group while focusing on the feature other than the feature considered as important in the current labeling.

For example, it is assumed that the rule “a” included in the first rule is “a post including 500 characters or more is to be monitored.” Further, it is assumed that the administrator adds, through the monitoring, a determined fraud label indicating the fraud to most of target data on posts including 500 characters or more. In this case, the first learning model M1 considers, of features of the target data, the number of characters as important. Even when another item other than the number of characters is important as the feature indicating the fraudulent act of the user, the first learning model M1 may focus on only the number of characters, and may not be able to notice a feature of another item.

Meanwhile, the second group includes many pieces of target data including characters the number of which is smaller than 500. The first learning model M1 executes the labeling while the number of characters is considered as important, and hence, when the target data belonging to the second group is simply input to the first learning model M1, the first learning model M1 executes the labeling while greatly focusing on the number of characters, and the label indicating non-fraud is added to most of the target data. By causing the distribution of the second group to be close to the distribution of the first group, the first learning model M1 comes to execute labeling while focusing on another feature other than the number of characters. For example, when the number of times of use of the user who conducts the fraudulent act tends to be large, the first learning model M1 comes to focus on not only the number of characters but also the number of times of use of the target data. In other words, the first learning model M1 comes to be capable of identifying a feature of the target data which does not distinguish the first group and the second group from each other (that is, a feature which cannot be distinguished through the current first rule).

For example, the server 10 creates the second learning model M2 based on the first group labeled through the monitoring and the second group labeled by the first learning model M1. The second learning model M2 uses the larger amount of training data than that of the first learning model M1, learns, through the second group, other features (for example, the number of times of use) which cannot be captured by the first rule, and thus has higher accuracy for the fraud detection than that of the first learning model M1. The second learning model M2 may be created based on only the second group, but the feature of the first group is also important for the fraud detection, and hence it is assumed that the second learning model M2 is created based on both of the first group and the second group. The second learning model M2 can be used for various purposes. Examples of the use of the second learning model M2 are described in the modification examples described later.

As described above, in this embodiment, without the execution of the monitoring of the second group by the administrator, the second group can accurately be labeled. Thus, the second group which does not satisfy the first rule can be labeled without time and effort. A detailed description is now given of the learning system S.

### 3. Functions Implemented by Learning System

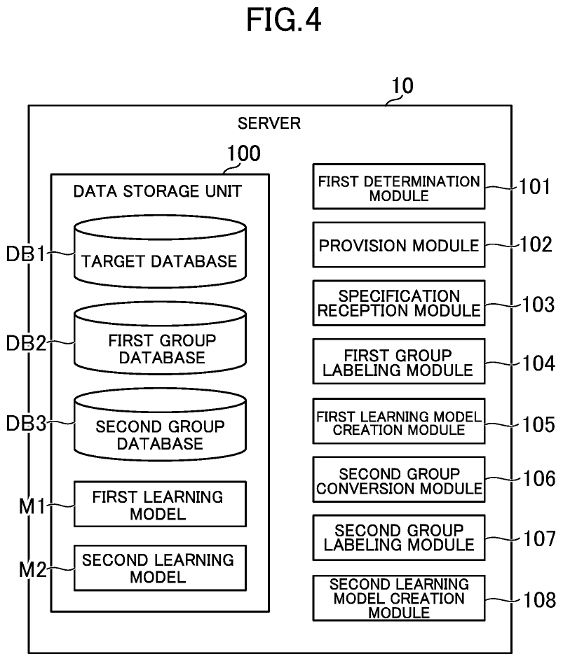

FIG. 4 is a functional block diagram for illustrating an example of functions implemented in the learning system S. In this embodiment, description is given of a case in which main functions are implemented by the server 10. A data storage unit 100 is implemented mainly by the storage unit 12. Each of the other functions is implemented mainly by the control unit 11.

### [3-1. Data Storage Unit]

The data storage unit 100 stores data required for the fraud detection. For example, the data storage unit 100 stores the target database DB1, a first group database DB2, and a second group database DB3.

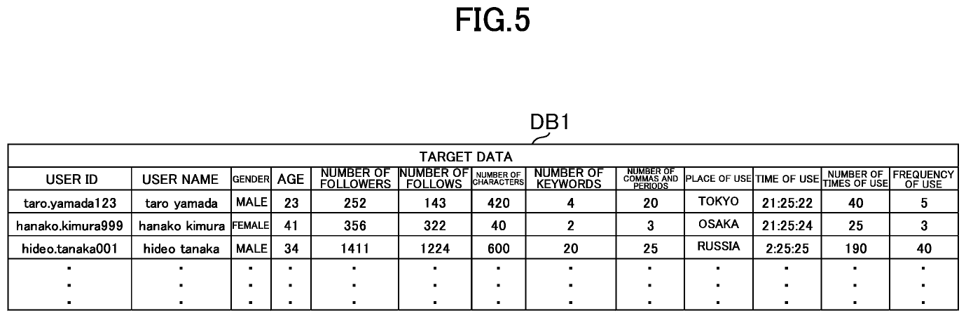

FIG. 5 is a table for showing an example of the target database DB1. The target database DB1 is a database which stores the target data. For example, the target data includes items such as the user ID, a user name, the gender, the age, the number of followers, the number of follows, the number of characters of the post, the number of keywords included in the post, the number of commas and periods included in the post, the place of use, the time of use, the number of times of use, and the frequency of use.

In this embodiment, description is given of a case in which the target data is generated each time a post on the SNS is received, but the target data can be generated at any timing, and the timing is not limited to the example of this embodiment. For example, the target data may be generated after a certain time has elapsed since the post on the SNS was received. For example, the target data may be generated when the administrator executes a predetermined operation on the administrator terminal 30.

In the example of FIG. 5, description is given of a case in which thirteen items are included in the target data, but the number of items included in the target data may be more or less than thirteen. The target data can include any items which can be used for the fraud detection, and the items are not limited to the example of FIG. 5. For example, there may exist another item such as the number of new paragraphs included in the post, the number of pictographs included in the post, the number of spaces included in the post, an elapsed time since issuance of the user ID, or a trajectory of a mouse pointer. It is assumed that items to be included in the target data are specified by the administrator.

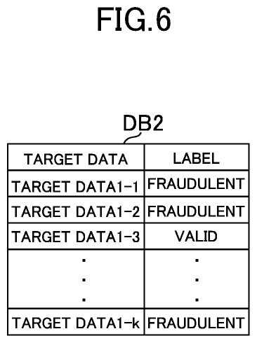

FIG. 6 is a table for showing an example of the first group database DB2. The first group database DB2 is a database which stores the target data belonging to the first group. For example, pairs each formed of the target data belonging to the first group and the label added through the monitoring by the administrator are stored in the first group database DB2. When the number of pieces of the target data belonging to the first group is “k”, “k” pairs are stored in the first group database DB2.

The pairs each formed of the target data and the label and stored in the first group database DB2 correspond to training data for the first learning model M1. In this embodiment, those pairs also correspond to training data for the second learning model M2. Thus, the first group database DB2 can be considered as a database which stores the training data for the first learning model M1, and can also be considered as a database which stores the training data for the second learning model M2. In the example of FIG. 6, description is given of a case in which both of the target data determined as fraud and the target data determined as non-fraud (that is, the target data determined as valid) are used as the training data for the first learning model M1 and the second learning model M2, but only the target data determined as fraud may be used as the training data for the first learning model M1 and the second learning model M2.

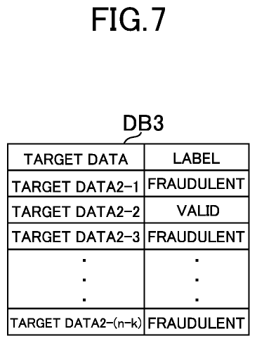

FIG. 7 is a table for showing an example of the second group database DB3. The second group database DB3 is a database which stores the target data belonging to the second group. For example, the target data belonging to the second group and the label added by the first learning model M1 are stored in the second group database DB3. When the number of pieces of the target data belonging to the second group is n-k, n-k pairs are stored in the second group database DB3.

The pairs each formed of the target data and the label and stored in the second group database DB3 correspond to training data for the second learning model M2. Thus, the second group database DB3 can be considered as a database which stores the training data for the second learning model M2. In this embodiment, it is assumed that the target data belonging to the second group is not to be monitored by the administrator, but a part of this target data may be monitored. For example, a part of the target data belonging to the second group that is estimated as fraud by the first learning model M1 may be monitored. In the example of FIG. 7, description is given of a case in which both of the target data determined as fraud and the target data determined as non-fraud (that is, the target data determined as valid) are used as the training data for the first learning model M1 and the second learning model M2, but only the target data determined as fraud may be used as the training data for the first learning model M1 and the second learning model M2.

For example, the data storage unit 100 stores the first learning model M1 and the second learning model M2. Each of the first learning model M2 and the second learning model M2 includes a program portion for calculating the feature amount of the target data and a parameter portion referred to in the calculation of the feature amount. The first learning model M1 has learned, as the training data, the pairs each formed of the target data and the label stored in the first group database DB2. The second learning model M2 has learned, as the training data, the pairs each formed of the target data and the label stored in the second group database DB3.

The data stored in the data storage unit 100 is not limited to the above-mentioned example. The data storage unit 100 may store any data required to label the target data. For example, the data storage unit 100 may store a user database which stores basic information on users who have registered to use the SNS. In the user database, the basic information such as the user IDs, the passwords, and the names are stored. For example, the data storage unit 100 may store the current learning model M0. For example, the data storage unit 100 may store data on the first rule.

### [3-2. First Determination Module]

A first determination module 101 determines whether or not each of the plurality of pieces of the target data satisfies the first rule. The first determination module 101 determines whether or not each of piece of the target data satisfies the first rule. In the example of FIG. 3, description is given of the case in which all of the “n” pieces of target data stored in the target database DB1 is to be determined by the first determination module 101, but only a part of the “n” pieces of target data may be determined by the first determination module 101. For example, of the “n” pieces of target data, only target data generated in a certain period immediately before or only a predetermined number of pieces of target data selected randomly may be determined by the first determination module 101.

In the example of FIG. 3, the first determination module 101 determines whether or not each of the “n” pieces of target data satisfies each of the plurality of rules such as the rule “a”, the rule “b”, . . . included in the first rule. It is only required to determine whether or not the target data satisfies each rule through comparison with a threshold value or string matching. In this embodiment, it is assumed that the first determination module 101 determines that the target data satisfies the first rule when the target data satisfies any one of the plurality of rules included in the first rule. The first determination module 101 may determine that the target data satisfies the first rule when the target data satisfies a predetermined number or more of the plurality of rules included in the first rule. The first determination module 101 may calculate a score of the target data based on a result of determination of whether or not the target data satisfies each of the plurality of rules included in the first rule, and determine that the target data satisfies the first rule when this calculated score is equal to or larger than a threshold value.

Each of the “n” pieces of target data stored in the target database DB1 is an example of the first data. Thus, “target data” in this embodiment can be read as “first data.” The first data is data to be determined by the first determination module 101. The first data can also be considered as the data to be labeled. When the learning system S is used for the fraud detection as in this embodiment, the first data is data being the target of the fraud detection.

The first rule is an example of a first condition. Thus, “first rule” in this embodiment can be read as “first condition.” The first condition is a condition relating to the labeling. The first condition is a criterion for the determination by the first determination module 101. The label is added to the target data based on the first condition. For example, when the target data satisfying the first condition is to be monitored as in this embodiment, the first condition can be considered as a condition indicating whether or not the target data is to be monitored. When the target data is to be monitored, the target data is labeled by the administrator, and hence the first condition corresponds to a condition relating to the labeling. The first condition can be any condition, and is not limited to the first rule. The first condition may be a condition conforming to the current learning model M0 or a conditional branching which is not called “rule.”

In this embodiment, the target data indicates the action of the user who uses the SNS. The SNS is an example of a predetermined service. Thus, “SNS” in this embodiment can be read as “predetermined service.” As in the modification examples described later, the predetermined service may be any other service. The predetermined service is provided based on the user information on the user. The user information is information registered by the user. The above-mentioned static items correspond to the user information. The labeling in this embodiment is processing of determining whether or not the action of the user having valid user information is fraudulent. The user having the valid user information is a user who uses the own user ID and password to log in. The label in this embodiment is a determined fraud label indicating that the fraud is determined.

### [3-3. Provision Module]

A provision module 102 provides the target data satisfying the first rule to the administrator who executes the labeling. The provision of the target data to the administrator is transmission of the target data to the administrator terminal 30. The provision module 102 provides the “k” pieces of target data belonging to the first group and stored in the first group database DB2 to the administrator. For example, when the server 10 receives a predetermined request from the administrator terminal 30, the provision module 102 transmits the “k” pieces of target data belonging to the first group to the administrator terminal 30, to thereby provide the “k” pieces of target data to the administrator.

### [3-4. Specification Reception Module]

A specification reception module 103 receives the specification for the label by the administrator. In this embodiment, the specification reception module 103 is implemented by the server 10, and hence the specification reception module 103 receives data indicating a result of specification by the administrator from the administrator terminal 30, to thereby receive the specification of the label by the administrator. In this embodiment, description is given of the case in which the administrator manually specifies the label for each of all of the pieces of target data provided to the administrator, but a provisional label may be added to the target data in advance, and the administrator may check the label. The target data provided to the administrator satisfies the first rule, and hence the provisional label indicates the fraud. When the provisional label is erroneous, the administrator may correct the error.

### [3-5. First Group Labeling Module]

A first group labeling module 104 labels the first group.

In this embodiment, the monitoring is executed by the administrator, and hence the first group labeling module 104 labels the first group based on the specification by the administrator. In this embodiment, the administrator manually specifies the label for each of all of the pieces of target data provided to the administrator, and hence the first group labeling module 104 associates the target data provided to the administrator and the labels specified by the administrator with each other, to thereby label the first group.

When the administrator checks the provisional label, the first group labeling module 104 associates the target data provided to the administrator and a result of check by the administrator with each other, to thereby label the first group. The first group labeling module 104 labels the first group so that, to the target data the provisional label of which has not been corrected by the administrator, this provisional label is added as the actual label. The first group labeling module 104 labels the first group so that, to the target data the provisional label of which has been corrected by the administrator, this label corrected by the administrator is added.

For the first group, the monitoring by the administrator may not be executed. In this case, the first group labeling module 104 may label the first group based on the result of determination by the first determination module 101. For example, in the case in which it is determined in advance to add the label indicating the fraud when the first rule is satisfied, the first group labeling module 104 may add the label indicating the fraud to the target data belonging to the first group, to thereby label the first group.

Moreover, for example, the label may be associated with each rule included in the first rule. For example, the label may be associated with each rule such that when the target data satisfies the rule “a”, the label indicating the fraud is added to this target data, and when the target data satisfies the rule “b”, the label indicating the non-fraud is added to this target data. The first group labeling module 104 may add, to the target data, the label associated with the rule satisfied by this target data, to thereby label the first group.

### [3-6. First Learning Model Creation Module]

A first learning model creation module 105 creates the first learning model M1 capable of labeling based on the first group being the group of the pieces of the target data which satisfy the first rule and which are labeled. The creation of the first learning model M1 is to execute learning processing for the first learning model M1. That is, causing the first learning model M1 to learn the training data corresponds to the creation of the first learning model M1. As the learning processing itself, various methods used for the machine learning can be used. For example, for the learning processing, the back propagation method or the gradient descent method may be used. For example, the first learning model creation module 105 uses, as the training data, the pairs each formed of the target data belonging to the first group and the label added to this target data to create the first learning model M1. The first learning model creation module 105 adjusts, when the target data belonging to the first group is input to the first learning model M1, the parameters of the first learning model M1 so that the label associated with this target data is output from the first learning model M1. The first learning model creation module 105 may use all of the target data stored in the first group database DB2 as the training data, or may use only a part of the target data as the training data.

### [3-7. Second Group Conversion Module]

A second group conversion module 106 converts the second group being the group of the pieces of first data which do not satisfy the first rule and which are not labeled so that the distribution of the second group is close to the distribution of the first group. Converting the second group is changing the feature amounts of the target data belonging to the second group. The second group conversion module 106 converts the second group based on a predetermined conversion function. As the conversion function itself, publicly-known various functions can be used, and, for example, a function as described in Non Patent Literature 1 may be used.

The second group conversion module 106 converts the second group based on a method of matching a domain being a source and a domain being a target with each other. As this method, publicly-known various methods can be used, and, for example, a method described as the related art of Non Patent Literature 1 may be used. For example, the second group conversion module 106 may convert the second group based on a method of repeating processing of selecting a sample from the domain being the source and processing of determining weight coefficients of the conversion function (Borgwardt, Karsten M., Gretton, Arthur, Rasch, Malte J., Kriegel, Hans-Peter, Scholkopf, Bernhard, and Smola, Alexander J., Integrating structured biological data by Kernel Maximum Mean Discrepancy, in ISMB, pp. 49-57, 2006).

For example, the second group conversion module 106 may convert the second group based on a method of searching for coefficients for converting a probability distribution of the domain being the source to a probability distribution of the domain being the target (Pan, Sinno Jialin, Tsang, Ivor W., Kwok, James T., and Yang, Qiang, Domain Adaptation via Transfer Component Analysis, IEEE Transactions on Neural Networks, 22 (2): 199-210, 2011). For example, the second group conversion module 106 may convert the second group based on a method called “kernel-reproducing Hilbert space” (Gong, Boqing, Shi, Yuan, Sha, Fei, and Grauman, Kristen, Geodesic Flow Kernel for Unsupervised Domain Adaptation, in CVPR, pp. 2066-2073, 2012).

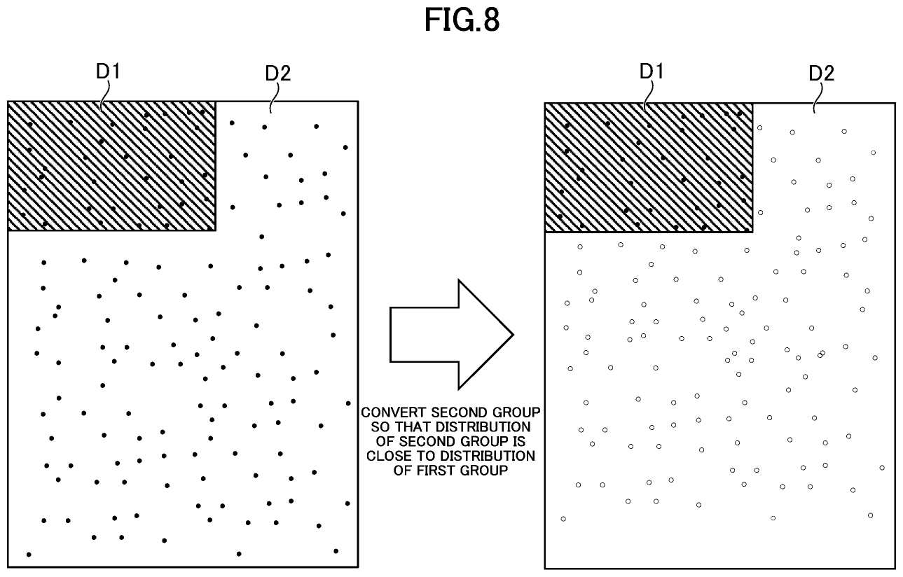

FIG. 8 is a diagram for illustrating an example of the processing of converting the second group. In FIG. 8, a distribution D1 of the first group is hatched, and a distribution D2 of the second group is not hatched. A state in which the feature amounts of the target data belonging to the first group and the feature amounts of the target data belonging to the second group are plotted in a multi-dimensional space is indicated by black dots or white dots. The black dots of FIG. 8 indicate the non-converted feature amounts, and the white dots indicate the converted feature amounts.

As illustrated in FIG. 8, the target data belonging to the first group satisfies the first rule, and hence the distribution of the feature amounts is concentrated within a certain range. The target data belonging to the second group does not satisfy the first rule, and hence the distribution of the feature amounts is different from the distribution of the first group. The second group conversion module 106 converts the target data belonging to the second group so that the distribution of the feature amounts of the second group is close to the distribution of the feature amounts of the first group. For example, the distribution D2 of the second group after the conversion is close to the distribution of the first group D1.

For example, the second group conversion module 106 calculates average values of the feature amounts of the “k” pieces of target data belonging to the first group as a representative value of the distribution D1 of the first group. The second group conversion module 106 calculates average values of the feature amounts of the n-k pieces of target data belonging to the second group as a representative value of the distribution D2 of the second group. The second group conversion module 106 converts the second group so that the representative value of the distribution D2 of the second group is close to the representative value of the distribution D1 of the first group.

When the first learning model M1 considers the number of characters as important as in the above-mentioned example, this conversion is executed such that a portion of the feature amounts of the target data belonging to the second group that corresponds to the number of characters is close to the first group (for example, as if the number of characters of the target data belonging to the second group which is actually smaller than 500 characters were equal to or larger than 500 characters). As a result, the distribution D2 of the second group is close to the distribution D1 of the first group as a whole. The representative values of the distributions D1 and D2 in the above-mentioned example may not be the average values of the feature amounts of the entire first group and the entire second group, respectively. For example, the representative value may be average values of the feature amounts of target data selected randomly, or feature amounts at a mode of the probability distribution.

### [3-8. Second Group Labeling Module]

A second group labeling module 107 labels the second group based on the first learning model M1 and the second group converted by the second group conversion module 106. The second group labeling module 107 inputs the target data belonging to the second group after the conversion to the first learning model M1, and associates this target data with the output from the first learning model M1 with each other, to thereby label the second group. When the first learning model M1 outputs the score, the second group labeling module 107 may associate the target data belonging to the second group with the score output from the first learning model M1, to thereby execute the labeling.

### [3-9. Second Learning Model Creation Module]

A second learning model creation module 108 creates, based on the first group and the second group labeled by the second group labeling module 107, the second learning model M2 which is different from the first learning model M1 and which is capable of labeling. The creation of the second learning model M2 is to execute learning processing for the second learning model M2. That is, causing the second learning model M2 to learn the training data corresponds to the creation of the second learning model M2. As the learning processing itself, various methods used for the machine learning can be used. For example, for the learning processing, the back propagation method or the gradient descent method may be used.

For example, the second learning model creation module 108 uses, as the training data, the pairs each formed of the target data belonging to the first group and the label added to this target data to create the second learning model M2. The second learning model creation module 108 adjusts, when the target data belonging to the first group is input to the second learning model M2, the parameters of the second learning model M2 so that the label associated with this target data is output from the second learning model M2. The second learning model creation module 108 may use all of the target data stored in the first group database DB2 as the training data, or may use only a part of the target data as the training data.

For example, the second learning model creation module 108 uses, as the training data, the pairs each formed of the target data belonging to the second group and the label added to this target data to create the second learning model M2. The second learning model creation module 108 adjusts, when the target data belonging to the second group is input to the second learning model M2, the parameters of the second learning model M2 so that the label associated with this target data is output from the second learning model M2. The second learning model creation module 108 may use all of the target data stored in the second group database DB3 as the training data, or may use only a part of the target data as the training data.

In this embodiment, it is assumed that the second learning model creation module 108 creates the second learning model M2 based on the second group being labeled by the second group labeling module 107 and before being converted by the second group conversion module 106, but the second learning model creation module 108 may create the second learning model M2 based on the second group after being converted by the second group conversion module 106. Moreover, for example, the second learning model creation module 108 may create the second learning model M2 based on the second group before being converted by the second group conversion module 106 and the second group after being converted by the second group conversion module 106.

### 4. Processing Executed in Learning System

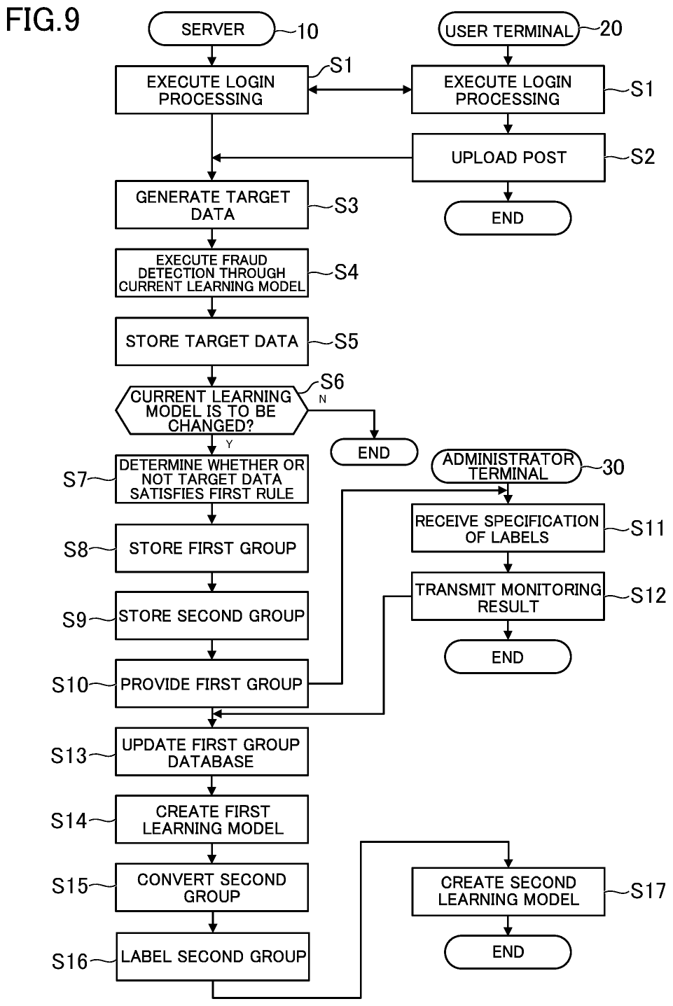

FIG. 9 is a flowchart for illustrating an example of processing executed in the learning system S. The processing in FIG. 9 is executed by the server 10, the user terminal 20, and the administrator terminal 30. The processing of FIG. 9 is executed by the control units 11, 21, and 31 operating in accordance with the programs stored in the storage units 12, 22, and 32, respectively.

As illustrated in FIG. 9, the user terminal 20 accesses the server 10 to execute login processing between the user terminal 20 and the server 10 for logging in to the SNS (Step S1). The user terminal 20 uploads a post to the server 10 (Step S2). When the post is received, the server 10 generates the target data (Step S3), and executes the fraud detection based on the learning model M0 being the current fraud detection model (Step S4). It is only required that the generation of the target data in Step S3 be executed based on the data received from the user terminal 20 and the user database stored in the server 10. It is assumed that the post is not received when the fraud is detected at the time of the processing step of Step S4. When the fraud is not detected, the post is received.

The server 10 stores the target data generated in Step S3 in the target database DB1 (Step S5). The server 10 determines whether or not to change the learning model M0 being the current fraud detection model (Step S6). When it is not determined to change the current fraud detection model (N in Step S6), this processing is finished. When it is determined to change the current fraud detection model (Y in Step S6), the server 10 refers to the target database DB1, and determines whether or not each of the “n” pieces of target data satisfies the first rule (Step S7).

The server 10 stores, as the first group, the “k” pieces of target data satisfying the first rule in the first group database DB2 (Step S8). The server 10 stores, as the second group, the n-k pieces of target data not satisfying the first rule in the second group database DB3 (Step S9). The server 10 provides the first group to the administrator based on the first group database DB2 (Step S10).

When the first group is received, the administrator terminal 30 receives the specification of the labels by the administrator (Step S11). In Step S11, the monitoring by the administrator is executed. The administrator terminal 30 transmits the result of monitoring by the administrator to the server 10 (Step S12). When the result of monitoring by the administrator is received, the server 10 updates the first group database DB2 (Step S13).

The server 10 creates the first learning model M1 based on the first group labeled by the administrator (Step S14). In Step S14, the server 10 uses, as the training data, the pairs each formed of the target data and the label stored in the first group database DB2 to execute the learning processing for the first learning model M1. The server 10 adjusts, when the target data belonging to the first group is input, the parameters of the first learning model M1 so that the label corresponding to this target data is output.

The server 10 converts the second group so that the distribution of the second group is close to the distribution of the first group based on the first group database DB2 and the second group database DB3 (Step S15). The server 10 labels the second group based on the second group converted in Step S15 and the first learning model M1 created in Step S14 (Step S16). In Step S16, the server 10 inputs the target data belonging to the second group to the first learning model M1, to thereby acquire the output from the first learning model M1. The server 10 updates the second group database DB3 so that each piece of the target data input to the first learning model M1 and each of the labels output from the first learning model M1 are paired.

The server 10 creates the second learning model M2 based on the labeled first group and the labeled second group (Step S17), and this processing is finished. In Step S17, the server 10 uses, as the training data, both of the pairs of the target data and the labels stored in the first group database DB2 and the pairs of the target data and the labels stored in the second group database DB3, to thereby execute the learning processing for the second learning model M2. The server 10 adjusts, when the target data belonging to the first group is input, the parameters of the second learning model M2 so that the label corresponding to this target data is output. The server 10 adjusts, when the target data belonging to the second group is input, the parameters of the second learning model M2 so that the label corresponding to this target data is output.

As described above, the learning system S according to this embodiment creates the first learning model M1 based on the first group. The learning system S converts the second group so that the distribution of the second group is close to the distribution of the first group. The learning system S labels the second group based on the first learning model M1 and the converted second group. With this configuration, the target data which does not satisfy the first rule can be labeled without time and effort. For example, even when the second group is not to be monitored by the administrator, the second group can accurately be labeled. The administrator is not required to monitor the second group, and hence the load on the administrator can be reduced. The second group is not monitored, and hence the time required to label the second group can be reduced. As a result, the fraudulent act can quickly be detected from the target data belonging to the second group. When a fraudulent act of the user which causes a decrease in the security in the SNS is to be detected, the security in the SNS is increased.

Moreover, the learning system S creates the second learning model M2 based on the first group and the labeled second group. As a result, it is possible to create, without time and effort, the second learning model M2 capable of detecting the fraudulent act of the user more accurately than the first learning model M1. The second group is not monitored, and hence the time required to create the second learning model M2 can be reduced. As a result, the second learning model M2 capable of detecting the fraudulent act of the user can quickly be created, and hence the fraudulent act of the user is easily detected. When the fraudulent act of the user which causes a decrease in the security in the SNS is to be detected, the security in the SNS is increased.

Moreover, the learning system S creates the second learning model M2 based on the second group before being converted. As a result, it is possible to create the second learning model M2 which has more accurately learned the feature of the fraudulent act of the user. As a result, the fraudulent act of the user is easily detected. When the fraudulent act of the user which causes a decrease in the security in the SNS is to be detected, the security in the SNS is increased.

Moreover, the learning system S provides the first data belonging to the first group to the administrator, to thereby receive the specification of the labels by the administrator. The learning system S executes the labeling for the first group based on the specification by the administrator. As a result, the target data to be monitored by the administrator can be narrowed down to the minimum target data, and hence the load on the administrator is reduced. Moreover, the monitoring result of the administrator can be reflected to the first learning model M1, and the accuracy of the first learning model M1 consequently increases. As a result, the accuracy of the second group labeling also increases through use of the highly accurate first learning model M1.

Moreover, the target data indicates the action of the user who uses the SNS, and the SNS is provided based on the user information. The labeling for the target data is the processing of determining whether or not the action of the user having the valid user information is fraudulent, and the label is the determined fraud label indicating that the fraud is determined. As a result, the labeling for detecting the fraudulent act of the user in the SNS can be executed without time and effort. Accordingly, the fraudulent act of the user in the SNS is easily detected.

### 5. Modification Examples

The present disclosure is not limited to the embodiment described above, and can be modified suitably without departing from the spirit of the present disclosure.

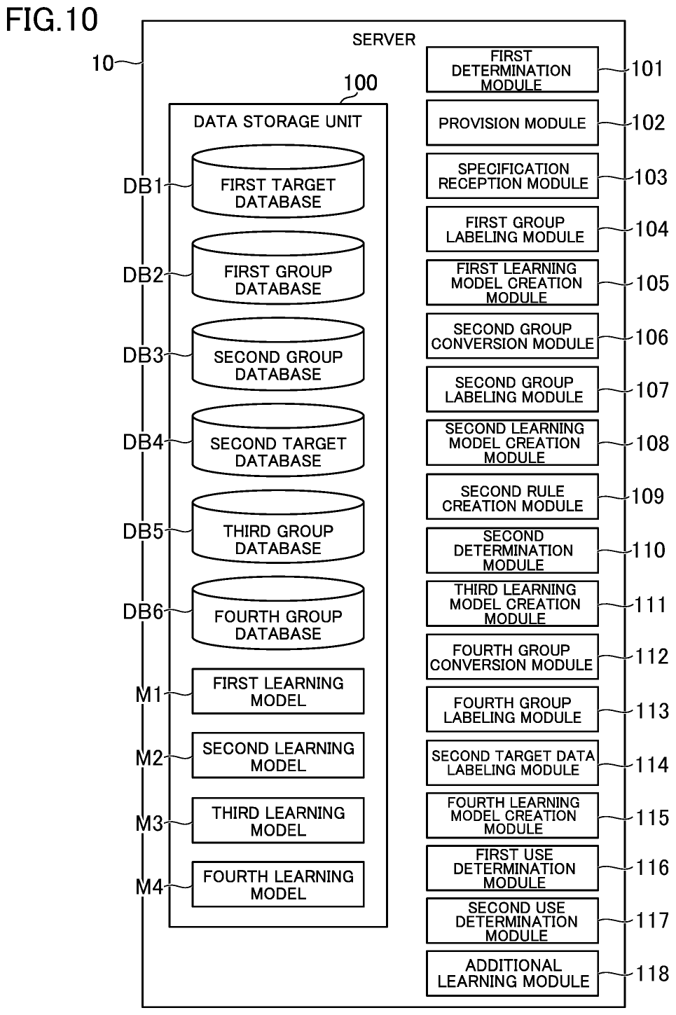

FIG. 10 is diagram for illustrating an example of functional blocks in the modification examples. As illustrated in FIG. 10, there are implemented a second rule creation module 109, a second determination module 110, a third learning model creation module 111, a fourth group conversion module 112, a fourth group labeling module 113, a second target data labeling module 114, a fourth learning model creation module 115, a first use determination module 116, a second use determination module 117, and an additional learning module 118. Those functions are mainly implemented by the control unit 11. In the modification examples, the target database DB1 described in the embodiment is referred to as “first target database DB1.”

### 5-1. Modification Example 1

For example, the learning system S can also be applied to the fraud detection in a service other than the SNS. The another service may be of any type, and, for example, a payment service, an electronic commerce service, a travel reservation service, a financial service, or a communication service. In Modification Example 1, the fraud detection in the payment service is exemplified. In Modification Example 2 to Modification Example 10, the fraud detection in the payment service is also exemplified, but the learning system S can similarly be applied to any service also in Modification Example 2 to Modification Example 10.

The payment service is a service relating to electronic payment. The electronic payment is also sometimes called “cashless payment.” In Modification Example 1, electronic payment through use of a credit card is exemplified, but payment means available in the payment service may be of any type, and is not limited to the credit card. For example, electronic money, reward points, a bank account, a debit card, or a cryptocurrency asset may correspond to the payment means. For example, a code such as a barcode or a two-dimensional code is also sometimes used for the electronic payment, and hence the code may correspond to the payment means. The payment service is available for various purposes such as remittance to another user or loading of money in addition to the payment at a store.

For example, the user can use not only a physical credit card, but also a credit card registered in a payment application installed in the user terminal 20. Not only the credit card registered in the payment application, but also a credit card registered in another service such as the electronic commerce service or the travel reservation service may be used. For example, a malicious third party may not steal the physical credit card, but may illegally obtain a user ID and a password to impersonate a valid user, to thereby use the credit card.

As in the SNS described in the embodiment, the feature of the fraudulent act of the third party and the feature of the fraudulent act of the user are sometimes different from each other also in the payment service. In the payment service, a fraud by a clerk of a member store is given as an example of the fraudulent act of the user. It is assumed that the clerk of the member store has registered to use the payment service. Thus, the clerk of the member store is also a user. For example, the clerk of the member store may use an own credit card on a POS terminal of the own store to pretend that an article which is not actually sold is purchased, to thereby cash the credit card or to purchase an article such as a coupon which cannot be purchased with a credit card. The fraud by the clerk of the member store is hereinafter referred to as “fraud of the member store.”

When the third party impersonates a valid user to fraudulently use a credit card, the valid user often notices the fraudulent use of the own credit card, and reports the fraud to an administrator of the payment service, and hence the administrator is likely to notice the fraud of the third party. Meanwhile, when the clerk of the member store acts the fraud, the clerk of the member store uses the own credit card to act the fraud, and hence a substantial victim is only an issuer of the credit card or a provider of the payment service. In this case, no one reports to the administrator, and hence the administrator is less likely to notice the fraudulent act of the member store.

Thus, processing equivalent to that in the embodiment can also be applied to the fraud detection in the payment service. The target data in Modification Example 1 is data on a feature of the user in the payment service. For example, the target data includes items such as a card number, a brand, an amount of use, a place of use, a time of use, the number of times of use, and a frequency of use of the credit card. When information on a purchased article can be acquired, the information on the purchased article may be included in the target data.

The first rule in Modification Example 1 indicates a feature of the fraudulent act of the member store. The first determination module 101 determines whether or not the target data satisfies the first rule indicating the feature of the fraudulent act of the member store. The first group is a group of pieces of target data which satisfy the first rule indicating the feature of the fraudulent act of the member store, and which are to be monitored by the administrator and are thus labeled. The first learning model creation module 105 creates, based on this first group, the first learning model M1 which can detect the fraudulent act of the member store.

The second group is a group of pieces of target data which do not satisfy the first rule indicating the feature of the fraudulent act of the member store, and which are not to be monitored by the administrator and are not thus labeled. The second group conversion module 106 converts the second group so that the distribution of the second group is close to the distribution of the first group by a method equivalent to the method described in the embodiment. The second group labeling module 107 labels the second group based on the converted second group. The second learning model creation module 108 creates the second learning model M2. The second learning model M2 has learned features of the fraudulent act of the membership store that are not defined in the first rule.

For example, it is assumed that a rule relating to an amount of money of use is defined as the first rule. In this case, the first learning model M1 is a model which considers the amount of money of use as important. The second group is a group of pieces of the target data corresponding to relatively small amounts of money of use, but the first learning model M1 comes to focus on another feature (for example, the number of times of use) other than the amount of money of use by converting the second group so that the distribution of the second group is close to the distribution of the first group. The second learning model M2 executes the labeling while focusing on not only the amount of money of use, but also the another feature, and hence the labeling focusing on the feature that is not defined in the first rule can be executed.

The learning system S according to Modification Example 1 can label the target data in the payment service without time and effort for the same reason as that in the learning system S described in the embodiment. Moreover, for the same reason as that in the learning system S described in the embodiment, it is possible to accurately label the second group in the payment service, to reduce the load of the monitoring by the administrator in the payment service, to reduce the time required to label the second group in the payment service, to quickly detect the fraud from the target data in the payment service, and to quickly detect the fraudulent act of the member store in the payment service to increase the security.

### 5-2. Modification Example 2

For example, the second learning model M2 may be used to create a new rule different from the first rule. The new rule is hereinafter referred to as “second rule.” The second rule is a rule applied in place of the first rule. When the second rule is applied, the first rule comes not to be used. The purpose of use of the second rule is the same as that of the first rule. In Modification Example 2, as in Modification Example 1, description is given of the case in which the second rule is used to detect the fraud in the payment service. The second rule is an example of a second condition. Thus, “second rule” in this modification example can be read as “second condition.”

The second condition is different from the first condition, and is a condition relating to the labeling. The second condition is a criterion for determination by the second determination module 110 described later. The label is added to the target data based on the second condition. For example, when the target data satisfying the second condition is to be monitored as in Modification Example 2, the second condition can be considered as a condition indicating whether or not the target data is to be monitored. The second condition can be any condition, and is not limited to the second rule. It is only required that the second condition conform to the second learning model M2 and may be a conditional branching which is not called “rule.”

The learning system S according to Modification Example 2 includes the second rule creation module 109 and the second determination module 110. The second rule creation module 109 creates the second rule based on the second learning model M2. The second rule creation module 109 uses a predetermined rule creation method to create the second rule from the second learning model M2. As the rule creation method itself, a publicly-known method can be used. For example, the second rule creation module 109 may use the decision tree learning to create the second rule from the second learning model M2.

For example, the second rule creation module 109 may create the second rule based on an item of the target data to be considered as important when the second learning model M2 executes the labeling. This item may be determined based on an index called “impact value.” The impact value is a degree of importance in the labeling. As the impact value increases, the item is considered as more important in the labeling. The impact value itself can be acquired by publicly-known various methods, and the impact value may be acquired by, for example, a method of measuring influence of a change in the value of the item of the target data input to the second learning model M2 on the output of the second learning model M2. The second rule creation module 109 creates the second rule so that the second rule includes, as a conditional branching, an item having a relatively high impact value.

In Modification Example 2, the target data to be determined by the first determination module 101 described in the embodiment is referred to as “first target data.” The second determination module 110 determines whether or not each of a plurality of pieces of second target data different from the plurality of pieces of the first target data satisfies the second rule. The second target data is target data generated after the first target data. When the learning system S is used for the fraud detection in the payment service as in Modification Example 2, the second target data is data on the actions conducted after the first target data. For example, the second target data is data on the actions conducted immediately before. The items included in the second target data themselves are the same as those included in the first target data.

The second target data is an example of second data. Thus, “second target data” in this modification example can be read as “second data.” The second data is data to be determined by the second determination module 110. The second data can also be considered as the data to be labeled. When the learning system S is used for the fraud detection in the payment service as in Modification Example 2, the second data is data being the target of the fraud detection.

The learning system S in Modification Example 2 creates the second rule based on the second learning model M2. The learning system S determines whether or not each of the plurality of pieces of second target data satisfies the second rule. As a result, even when the first rule becomes old, the first rule can be updated to the new second rule. For example, in the case in which the learning system S is used for the fraud detection in the payment service as in Modification Example 2, even when tendency of the fraudulent acts changes as the time elapses, it is possible to respond to the newest tendency of the fraudulent acts by creating the second rule reflecting the newest tendency. As a result, the fraudulent act is quickly detected, thereby increasing the security of the payment service.

### 5-3. Modification Example 3

For example, the second rule in Modification Example 2 may be used for the fraud detection in the current payment service, but may be used to create new learning models. In Modification Example 3, description is given of a case in which the new learning models are created based on the second rule by executing processing equivalent to that in the embodiment. That is, the creation of the new learning models is repeated by repeating the processing described in the embodiment. The data storage unit 100 in Modification Example 3 stores a second target database DB4, a third group database DB5, and a fourth group database DB6.

The second target database DB4 is a database which stores the plurality of pieces of the second target data. In Modification Example 3, description is given of a case in which “n” pieces of second target data, which are as many pieces of target data as the pieces of the first target data stored in the first target database DB1, are stored in the second target database DB4, but the number of pieces of the second target data stored in the second target database DB4 may be any number. The creation method itself for the second target data may be equivalent to that for the first target data.

The third group database DB5 is a database which stores the second target data belonging to a third group. For example, pairs each formed of the second target data belonging to the third group and the label added through the monitoring by the administrator are stored in the third group database DB5. When the number of pieces of the second target data belonging to the third group is “k”, “k” pairs are stored in the third group database DB5. The pairs each formed of the second target data and the label and stored in the third group database DB2 correspond to training data for the third learning model M3.

The fourth group database DB6 is a database which stores the target data belonging to a fourth group. For example, the second target data belonging to the fourth group and the label added by the third learning model M3 are stored in the fourth group database DB6. When the number of pieces of the second target data belonging to the fourth group is n-k, n-k pairs are stored in the fourth group database DB6. The pairs each formed of the second target data and the label and stored in the fourth group database DB6 correspond to training data for the fourth learning model M4.

For example, the data storage unit 100 stores the third learning model M3 and the fourth learning model M4. Each of the third model M3 and the fourth model M4 includes a program portion for calculating the feature amount of the second target data and a parameter portion referred to in the calculation of the feature amount. The third learning model M3 has learned, as the training data, the pairs each formed of the second target data and the label stored in the third group database DB5. The fourth learning model M4 has learned, as the training data, the pairs each formed of the second target data and the label stored in the fourth group database DB6.

The learning system S according to Modification Example 3 includes a third learning model creation module 111, a fourth group conversion module 112, and a fourth group labeling module 113. The third learning model creation module 111 creates the third learning model M3 capable of labeling based on the third group being the group of the pieces of the second target data which satisfy the second rule and which are labeled. The processing of the third learning model creation module 111 is different from that of the first learning model creation module 105 in a point that the third group is used, but is equivalent to that of the first learning model creation module 105 in the other points. The third learning model creation module 111 uses, as the training data, the pairs each formed of the second target data belonging to the third group and the label added to this second target data to create the third learning model M3.

The fourth group conversion module 112 converts the fourth group being the group of the pieces of second target data which do not satisfy the second condition and which are not labeled so that the distribution of the fourth group is close to the distribution of the third group. The processing of the fourth group conversion module 112 is different from that of the second group conversion module 106 in a point that the third group and the fourth group are used, but is equivalent to that of the second group conversion module 106 in the other points. The fourth group conversion module 112 converts the fourth group based on a predetermined conversion function.

The fourth group labeling module 113 labels the fourth group based on the third learning model M3 and the fourth group converted by the fourth group conversion module 112. The processing of the fourth group labeling module 113 is different from that of the second group labeling module 107 in a point that the third learning model M3 and the fourth group are used, but is equivalent to that of the second group labeling module 107 in the other points. The fourth group labeling module 113 inputs the second target data after the conversion belonging to the fourth group to the third learning model M3, and associates this second target data with the output from the third learning model M3 with each other, to thereby label the fourth group.

The learning system S according to Modification Example 3 creates the third learning model M3 based on the third group. The learning system S converts the fourth group so that the distribution of the fourth group is close the distribution of the third group. The learning system S labels the fourth group based on the third learning model M3 and the converted fourth group. With this configuration, the second target data which does not satisfy the second rule can be labeled without time and effort. For example, when the learning system S is applied to the fraud detection for the payment service, the rule can continuously be updated to the rule capable of detecting the newest tendency of the fraudulent acts by repeating the processing in Modification Example 3.

### 5-4. Modification Example 4

For example, instead of the second learning model M2 being used to create the new second rule as in Modification Example 2, the second learning model M2 may be used as the current fraud detection model in place of the learning model M0 being the current fraud detection model. The learning system S includes the second target data labeling module 114. The second target data labeling module 114 labels each of the plurality of pieces of the second target data different from the plurality of pieces of the first target data based on the second learning model M2. For example, the second target data labeling module 114 inputs each of the plurality of pieces of the second target data to the second learning model M2, and acquires the output from the second learning model M2, to thereby label each of the plurality of the second target data.

The learning system S according to Modification Example 4 labels each of the plurality of pieces of the second target data based on the second learning model M2. As a result, accuracy of the labeling for the second target data increases. For example, when the learning system S is applied to the fraud detection for the payment service, the second learning model M2 reflecting the newest tendency of the fraudulent acts can be used to accurately execute the fraud detection in the payment service.

### 5-5. Modification Example 5

For example, Modification Example 3 may be applied to Modification Example 4, to thereby use the second learning model M2 as the second condition. The learning system S according to Modification Example 5 includes the third learning model creation module 111, the fourth group conversion module 112, and the fourth group labeling module 113 as in Modification Example 3. However, the processing of the third learning model creation module different from the processing described in Modification Example 3. The third learning model creation module 111 in Modification Example 5 creates the third learning model M3 capable of labeling based on the third group being the group of the pieces of the second data labeled by the second learning model M2. The processing of the fourth group conversion module 112 and the fourth group labeling module 113 is as described in Modification Example 3.

The learning system S according to Modification Example 5 creates the third learning model M3 based on the third group. The learning system S converts the fourth group so that the distribution of the fourth group is close to the distribution of the third group. The learning system S labels the fourth group based on the third learning model M3 and the converted fourth group. As a result, the second target data for which the fraud is not estimated by the second learning model M2 can be labeled without time and effort. For example, when the learning system S is applied to the fraud detection for the payment service, the model can continuously be updated to the model capable of detecting the newest tendency of the fraudulent acts by repeating the processing in Modification Example 5.

### 5-6. Modification Example 6

For example, in the Modification Example 3 or Modification Example 5, the fourth learning model M4 may be created based on the labeling result of the fourth group. In this case, the first target data belonging to the first group may be used as the training data.

The learning system S according to Modification Example 6 includes the fourth learning model creation module 115. The fourth learning model creation module 115 creates, based on the first group, the third group, and the fourth group labeled by the fourth group labeling module 113, the fourth learning model M4 which is different from any one of the first learning model M1, the second learning model M2, and the third learning model M3 and which is capable of labeling. The processing of the fourth learning model creation module 115 is different from that of the second learning model creation module 108 in the point that the first group, the third group, and the fourth group are used as the training data, but is equivalent to that of the second learning model creation module 108 in the other points.

The fourth learning model creation module 115 uses, as the training data, the pairs each formed of the first target data belonging to the first group and the label added to this first target data to create the fourth learning model M4. The fourth learning model creation module 115 uses, as the training data, the pairs each formed of the second target data belonging to the third group and the label added to this second target data to create the fourth learning model M4. The fourth learning model creation module 115 uses, as the training data, the pairs each formed of the second target data belonging to the fourth group and the label added to this second target data to create the fourth learning model M4.

The learning system S according to Modification Example 6 creates, based on the first group, the third group, and the labeled fourth group, the fourth learning model M4 which is different from any one of the first learning model M1, the second learning model M2, and the third learning model M3 and which is capable of labeling. As a result, it is possible to create, without time and effort, the fourth learning model M4 capable of detecting the fraudulent act of the user more accurately than the third learning model M3.

### 5-7. Modification Example 7

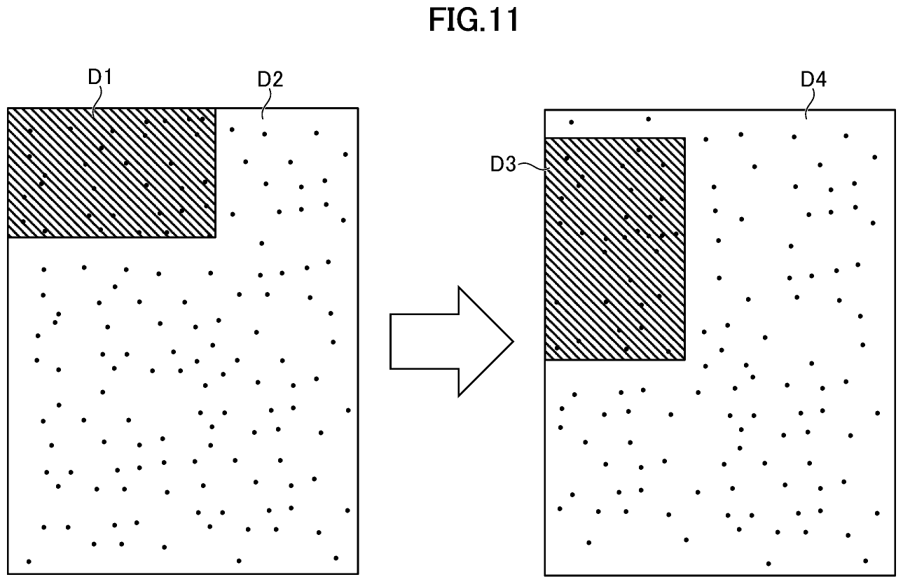

FIG. 11 is a diagram for illustrating an example of distributions of the first group to the fourth group. In FIG. 11, the distribution of the third group is denoted by reference symbol D3, and the distribution of the fourth group is denoted by reference symbol D4. For example, in Modification Example 6, when the distribution D1 of the first group and the distribution D3 of the third group are greatly apart from each other, it is likely that the newest tendency of the fraudulent acts has greatly changed. In this case, it is sometimes better not to use the first group for the learning for the fourth learning model M4. Thus, in Modification Example 7, when the distribution D1 of the first group and the distribution D3 of the third group are similar to each other, the first group is used for the learning for the fourth learning model M4.

The learning system S according to Modification Example 7 includes a first use determination module 116. The first use determination module 116 determines whether or not to use the first group to create the fourth learning model M based on similarity between the distribution D1 of the first group and the distribution D3 of the third group. The similarity between the distributions is how much the distributions are similar to each other. As a difference between the distributions becomes smaller, the distributions become more similar to each other. The similarity between the distributions is expressed based on a predetermined index. This index is hereinafter referred to as “similarity degree.”

The first use determination module 116 calculates the similarity degree based on the distribution D1 of the first group and the distribution D3 of the third group. For example, the first use determination module 116 calculates, based on the first target data belonging to the first group, a first representative value being the representative value of the feature amounts of the first target data. The first use determination module 116 calculates, based on the second target data belonging to the third group, a second representative value being the representative value of the feature amounts of the second target data. The meaning of the representative value is as described in the embodiment.

The first use determination module 116 calculates, as the similarity degree, a reciprocal of a distance between the first representative value and the second representative value. The similarity degree is the reciprocal of the distance, and hence the similarity degree increases as the distance decreases. The first use determination module 116 determines whether or not the similarity degree is equal to or higher than a predetermined threshold value. The first use determination module 116 determines not to use the first group to create the fourth learning model M4 when the similarity degree is lower than the threshold value, and determines to use the first group to create the fourth learning model M4 when the similarity degree is equal to or higher than the threshold value.

The fourth learning model creation module 115 creates the fourth learning model M4 not based on the first group when the first use determination module 116 does not determine to use the first group. In this case, the first target data belonging to the first group is not used as the training data for the fourth learning model M4. When the first use determination module 116 determines to use the first group, the fourth learning model creation module 115 creates the fourth learning model M4 based on the first group. In this case, the first target data belonging to the first group is used as the training data for the fourth learning model M4.

The learning system S according to Modification Example 7 determines whether or not to use the first group to create the fourth learning model M4 based on the similarity between the distribution D1 of the first group and the distribution D3 of the third group. The learning system S creates the fourth learning model M4 not based on the first group when the first group is not determined to be used, and creates the fourth learning model M4 based on the first group when the first group is determined to be used. As a result, the accuracy of the fourth learning model M4 increases.

### 5-8. Modification Example 8

For example, in Modification Example 6 or Modification Example 7, the fourth learning model creation module 115 may create the fourth learning model M4 further based on the second group labeled by the second group labeling module 107. The fourth learning model creation module 115 uses, as the training data, the pairs each formed of the first target data belonging to the second group and the label added to this second target data to create the fourth learning model M4. A point that this pair is used as the training data is different from Modification Example 6 or Modification Example 7, but the learning processing itself may be equivalent to that in Modification Example 6 or Modification Example 7.

The learning system S according to Modification Example 8 creates the fourth learning model further based on the second group labeled by the second group labeling module 107. As a result, it is possible to create, without time and effort, the fourth learning model M4 capable of detecting the fraudulent act of the user more accurately than the third learning model M3.

### 5-9. Modification Example 9

For example, in Modification Example 8, when the distribution D2 of the second group and the distribution D4 of the fourth group are greatly apart from each other, the second group may not be used for the learning for the fourth learning model M4 for the same reason as that in Modification Example 7. Thus, as in Modification Example 7, it may be determined whether or not the second group can be used to create the fourth learning model M4.

The learning system S according to Modification Example 9 includes the second use determination module 117. The second use determination module 117 determines whether or not to use the second group to create the fourth learning model based on the similarity between the distribution D2 of the second group and the distribution D4 of the fourth group. The meaning of the similarity is the same as that in Modification Example 7. The second use determination module 117 calculates the similarity degree based on the distribution D2 of the second group and the distribution D4 of the fourth group.

For example, the second use determination module 117 calculates a third representative value being a representative value of the feature amounts of the first target data based on the first target data belonging to the second group. The second use determination module 117 calculates, based on the second target data belonging to the fourth group, a fourth representative value being a representative value of the feature amounts of the second target data.

The second use determination module 117 calculates, as the similarity degree, a reciprocal of a distance between the third representative value and the fourth representative value. The similarity degree is the reciprocal of the distance, and hence the similarity degree increases as the distance decreases. The second use determination module 117 determines whether or not the similarity degree is equal to or higher than a predetermined threshold value. The second use determination module 117 determines not to use the second group to create the fourth learning model M4 when the similarity degree is lower than the threshold value, and determines to use the second group to create the fourth learning model M4 when the similarity degree is equal to or higher than the threshold value.

The fourth learning model creation module 115 creates the fourth learning model M4 not based on the second group when the second use determination module 117 does not determine to use the second group. In this case, the first target data belonging to the second group is not used as the training data for the fourth learning model M4. The fourth learning model creation module 115 creates the fourth learning model based on the second group when the second use determination module 117 determines to use the second group. In this case, the second target data belonging to the second group is used as the training data for the fourth learning model M4.

The learning system S according to Modification Example 9 determines whether or not to use the second group to create the fourth learning model based on the similarity between the distribution D2 of the second group and the distribution D4 of the fourth group. The learning system S creates the fourth learning model M4 not based on the second group when the second group is not determined to be used, and creates the fourth learning model M4 based on the second group when the second group is determined to be used. As a result, the accuracy of the fourth learning model M4 increases.

### 5-10. Modification Example 10

For example, in the embodiment, description is given of the case in which the new second learning model M2 is created as the labeling result of the second group, but the labeling result of the second group may be used for another purpose. In Modification Example 10, description is given of a case in which the labeling result of the second group is used for additional learning for the first learning model M1.

The learning system S according to Modification Example 10 includes the additional learning module 118. The additional learning module 118 executes, based on the second group labeled by the second group labeling module 107, additional learning for the first learning model that has learned the first group. As the learning processing itself in the additional learning, various methods used for the machine learning can be used. For example, for the learning processing, the back propagation method or the gradient descent method may be used. In the learning processing in the additional learning, processing employed in a method called “transfer learning” or “fine tuning” may be used.

For example, the additional learning module 118 uses, as the training data, the pairs each formed of the first target data belonging to the second group and the label added to this first target data to adjust the parameters of the first learning model M1. The additional learning module 118 adjusts, when the first target data belonging to the second group is input to the first learning model M1, the parameters of the first learning model M1 so that the label associated with this first target data is output from the first learning model M1. The additional learning module 118 may use all of the first target data stored in the second group database DB3 as the training data, or may use only a part of the first target data as the training data.

The learning system S according to Modification Example 10 executes, based on the labeled second group, the additional learning for the first learning model M1 that has learned the first group. As a result, the accuracy of the first learning model M1 increases.

### 5-11. Other Modification Examples

For example, the modification examples described above may be combined.

For example, the learning system S can be used for various purposes other than the fraud detection. The learning system S can be used for various types of labeling. The learning system S can be used also for, for example, labeling for objects included in an image, labeling for contents of a document, labeling for whether or not a user continuously uses a service, and labeling for taste of a user. For example, the learning system S may label the second group without creating the second learning model M2. The labels added to the target data belonging to the second group can be used for various purposes such as the fraud detection and marketing.

For example, the functions described as being implemented by the server 10 may be implemented by the administrator terminal 30, or may be implemented by another computer. For example, the functions described as being implemented by the server 10 may be shared by a plurality of computers. For example, the data to be stored in the data storage unit 100 may be stored in a database server different from the server 10.

The invention claimed is:

1. A learning system, comprising at least one processor configured to:
determine whether each of a plurality of pieces of first data satisfies a first condition relating to labeling;
create a first learning model capable of the labeling based on a first group being a group of pieces of the first data which satisfy the first condition and which are labeled;
convert a second group being a group of pieces of the first data which do not satisfy the first condition and which are not labeled so that a distribution of the second group is close to a distribution of the first group; and
execute the labeling for the second group based on the first learning model and the second group.

2. The learning system according to claim 1, wherein the at least one processor is configured to create, based on the first group and the second group, a second learning model which is different from the first learning model and which is capable of the labeling.

3. The learning system according to claim 2, wherein the at least one processor is configured to:
create, based on the second learning model, a second condition which is different from the first condition and which relates to the labeling; and
determine whether each of a plurality of pieces of second data different from the plurality of pieces of first data satisfies the second condition.

4. The learning system according to claim 3, wherein the at least processor configured to:
create a third learning model capable of the labeling based on a third group being a group of pieces of the second data which satisfy the second condition and which are labeled;
convert a fourth group being a group of pieces of the second data which do not satisfy the second condition and which are not labeled so that a distribution of the fourth group is close to a distribution of the third group; and
execute the labeling for the fourth group based on the third learning model and the fourth group.

5. The learning system according to claim 2, wherein the at least one processor is configured to execute, based on the second learning model, the labeling for each of a plurality of pieces of second data different from the plurality of pieces of first data.

6. The learning system according to claim 5, wherein the at least one processor is configured to:
create a third learning model capable of the labeling based on a third group being a group of pieces of the second data labeled by the second learning model;
convert a fourth group being a group of pieces of the second data which are not labeled by the second learning model so that a distribution of the fourth group is close to a distribution of the third group; and
execute the labeling for the fourth group based on the third learning model and the fourth group.

7. The learning system according to claim 4, wherein the at least one processor is configured to create, based on the first group, the third group, and the fourth group, a fourth learning model which is different from any one of the first learning model, the second learning model, or the third learning model and which is capable of the labeling.

8. The learning system according to claim 7, wherein the at least one processor is configured to:
determine, based on similarity between the distribution of the first group and the distribution of the third group, whether to use the first group to create the fourth learning model,
create the fourth learning model without based on the first group when it is not determined to use the first group, and to create the fourth learning model based on the first group when it is determined to use the first group.

9. The learning system according to claim 7, wherein the at least one processor is configured to create the fourth learning model further based on the second group.

10. The learning system according to claim 9, wherein the at least one processor is configured to:
determine, based on similarity between the distribution of the second group and the distribution of the fourth group, whether to use the second group to create the fourth learning model,
create the fourth learning model without based on the second group when it is not determined to use the second group, and to create the fourth learning model based on the second group when it is determined to use the second group.

11. The learning system according to claim 2, wherein the at least one processor is configured to create the second learning model based on the second group and before being converted.

12. The learning system according to claim 1, wherein the at least one processor is configured to execute, based on the second group, additional learning for the first learning model which has learned the first group.

13. The learning system according to claim 1, wherein the at least one processor is configured to:
provide the pieces of the first data satisfying the first condition to an administrator who executes the labeling;
receive specification for the label by the administrator; and
execute the labeling for the first group based on the specification by the administrator.

14. The learning system according to claim 1,
wherein each of the plurality of pieces of first data indicates an action of a user who uses a predetermined service,
wherein the predetermined service is provided based on user information on the user,
wherein the labeling is processing of determining whether the action of the user having valid user information is fraudulent, and
wherein the label is a determined fraud label indicating that the fraud is determined.

15. A learning method, comprising:
determining whether each of a plurality of pieces of first data satisfies a first condition relating to labeling;
creating a first learning model capable of the labeling based on a first group being a group of pieces of the first data which satisfy the first condition and which are labeled;
converting a second group being a group of pieces of the first data which do not satisfy the first condition and which are not labeled so that a distribution of the second group is close to a distribution of the first group; and
executing the labeling for the second group based on the first learning model and the second group.

16. A non-transitory computer-readable information storage medium for storing a program for causing a computer to:
determine whether each of a plurality of pieces of first data satisfies a first condition relating to labeling;
create a first learning model capable of the labeling based on a first group being a group of pieces of the first data which satisfy the first condition and which are labeled;
convert a second group being a group of pieces of the first data which do not satisfy the first condition and which are not labeled so that a distribution of the second group is close to a distribution of the first group; and
execute the labeling for the second group based on the first learning model and the second group.
